(19) United States
(12) Patent Application Publication
(10) Pub. No.: US 2009/0134287 A1
(43) Pub. Date: May 28, 2009

(54) Device for installing kitchens

(76) Inventor: Marek Klosowski, Aachen (DE)

Correspondence Address: THORPE NORTH & WESTERN, LLP., P.O. Box 1219, SANDY, UT, 84091-1219, US

(21) Appl. No.: 11/991,236

(22) PCT Filed: Aug. 25, 2006
(86) PCT No.: PCT/DE2006/001489

§ 371 Date: Feb. 29, 2008

(30) Foreign Application Priority Data
Aug. 29, 2005 (DE) 10 2005 041 017.0

(51) Int. Cl. F16M 11/32; F16M 11/00; F16M 11/20

(52) U.S. Cl. 248/172; 248/163.1; 248/440

(57) ABSTRACT

The invention relates to a device for installing kitchens comprised of kitchen elements such as lower cupboards, upper cupboards, shelves, kitchen appliances, worktops, sinks, etc., in which a base element, which stands on the floor, is provided for mounting at least one lower kitchen element. A vertically upwardly extending retaining element is joined to the rear end of the base element and can serve to fasten at least one upper kitchen element. The use of the device, which is problem-free not only for professional installers, makes it possible to install kitchen appliances regardless of the location of wall connections for electricity, water, gas, etc. The frame-like design eliminates the need to make holes in the kitchen wall for fastening the upper cupboards.

The invention concerns a device for installing kitchens that consists of kitchen elements such as lower cupboards, upper cupboards, kitchen appliances, a worktop, a sink, and so on. In generally known kitchen installations, kitchen units or blocks of several kitchen elements are usually set together. Moreover, the more usual kitchen elements such as, for example, lower cupboards, shelves, kitchen stoves and ovens, refrigerators, and sinks, as well as dishwashers and sometimes even washing machines, are used on the base of the kitchen installation. These lower kitchen elements are individually attached side by side with support feet on the kitchen floor. In addition, the worktop beneath the kitchen elements is ordinarily a manufactured slab made of wood, plastic, or other material.

Above the lower kitchen elements, at some distance from the worktop, are the rest of the kitchen elements, such as, for example, upper cupboards, hanging cupboards, suspended shelves, and a fume exhaust-hood (over the kitchen stove). These upper kitchen elements are usually attached to the kitchen wall by means of long screws, for which appropriate holes are drilled into the kitchen wall, and they have to be fitted with pegs. Finally, the wall surfaces between the upper and lower kitchen elements are frequently covered with wallboard. Instead of this, a so-called tile panel may also be used, that is, a manufactured strip made of ceramic tiles, whose height is determined by the distance between the corresponding upper and lower kitchen elements.

This customary manner of installing prefabricated kitchen elements first of all has the disadvantage that there are restrictions regarding the location of the kitchen appliances. Thus a dishwasher or sink must be built right at the location of the water connections at the kitchen wall. An electric or gas stove must be installed right against the kitchen wall where the power-supply or gas-line connection is located. This also holds true for a refrigerator or refrigerator-freezer combination, which must be built right at the location of a power-supply outlet.

Disregarding this fact is often detrimental, since the utility-line connection locations, for power, water/sewer, gas, and so on, are not adequately provided for at a kitchen wall, so that either additional, more expensive structural work has to be done or temporary solutions have to be carried out (multiple outlets, for example), in order to make possible the desired connections.

Furthermore, it is a disadvantage with the customary manner of installing kitchens that attaching the upper kitchen elements by means of the aforesaid screwed fastenings quite often proves to be difficult, when, for example, the kitchen wall is not very thick or is made of a material that does not have attachments securely screwed on (for instance in porous plaster) or when drilling into it may only be done with difficulty (such as in hard brickwork, natural stone, or tile and concrete walls). In this connection, there is also often the heavy weight of the upper cupboard or hanging cupboard, together with the contents (kitchen crockery and so on) to be taken into consideration, which introduces a high mechanical load on the wall-screw attachment. In particular, gypsum plasterboard walls prove to be a problem, with the heavy weight of an upper cupboards or hanging cupboard.

Moreover the utility lines laid out (electrical cables, water piping, gas lines, wastewater lines) are drilled underneath the plaster and are damaged more often and further damage is thereby done (for example, due to damage to the water lines, they have to be replaced, along with the associated supports, plastering, painting, and tilework as well). In addition, possible flooding of the owner's house may occur along with that of a neighbor's house, etc.), which is only corrected at great expense,

Very often, and certainly in old buildings, kitchen walls exhibit an uneven plaster construction. The difficulties associated with this, when hanging cupboards suspended in a series, turn out to be very time-consuming.

Furthermore, kitchens whose walls exhibit utilities, recesses, projections, odd-angled corners, and so forth, evoke special difficulties. Cutting out a worktop is often only possible on-site, and it requires a craftsman's knowledge to do this as well as professional tools. New worktops need to be cut out rapidly.

The usual kitchen system for sloping ceilings in attic-level homes allows for neither the installation of hanging cupboards, a tile panel, or all of the supply connections.

In addition, it is disadvantageous, for example, in removing the upper kitchen elements, to have to unscrew them from the wall and to attach them again in a new house on the kitchen wall, and to have to drill the appropriate holes for pegs and attachment screws for them to be fastened to. Upon disassembling or mounting them, a more substantial expenditure of time is generally known to be associated with this work.

Furthermore, the installation or assembly of the lower kitchen elements requires a great expenditure of time, to specially assemble these kitchen elements side by side and to have to make accurate adjustments so that they are set precisely horizontally on the kitchen worktops. Likewise, fitting this worktop is difficult, where there is also the disadvantage that local installation factors, such as when a worktop cut out in removal can frequently no longer be reused or can only be partially reused in another kitchen.

In addition, German Publication Document DE 24 52 628 A1, for a kitchen layout made up of prefabricated elements, is well-known. So a base section 1 (comprised of section rails 1 and 1a) for installing the lower cupboards and a rail 3 fastened horizontally to the wall for the suspended attachment of an upper cupboard, separate from one another, are provided. Both the base section and the hanging rail are so designed that a gap is established between the kitchen structural elements and the wall. This gap or intermediate space allows for the utility lines to be laid from the wall connections to the applicable kitchen appliances or water and outlet connections of the kitchen unit, but this kitchen layout still has the substantial disadvantage that the hanging rail 3 is also attached by screwing to the kitchen wall. In addition, mounting a sufficiently horizontally aligned base section 1 with a parallel section rail 1a as well as the hanging rail 3 is very expensive in order to achieve the accuracy required, particularly for the instructions or tools described in the document.

Thus the objective on which the invention is based is to create a device for installing kitchens that avoids the aforesaid disadvantages and is at the same time a simple, cost-beneficial, manufactured structural member, which, without greater expenditure, is suitable for the assembly and disassembly of kitchen elements in the kitchen concerned, without additional measures (such as drilling into the kitchen wall), and a kitchen unit can be constructed, and not just by professional installers, both in a problem-free manner and rapidly.

This objective would be met with a device of said type according to the invention which calls prior art into question, whereby the device exhibits a base element standing on the floor for the installation of at least one lower kitchen element, such as a lower cupboard, a sink, a kitchen stove and oven, a refrigerator, a dishwasher, a washing machine, and/or the like, and which is vertically attached at the back end of the base element to a retaining element that extends upward, in whose upper area means are provided for attaching at least one upper kitchen element, such as an upper cupboard, a hanging cupboard, a fume exhaust hood, and/or the like.

The device according to the invention for installing kitchens first of all has the advantage that the work procedure described at the beginning, is avoided, that is, for instance, making holes with pegs for the screwed fastening of upper cupboards and the like, which conveys an enormous savings in time or work. By not drilling into the kitchen wall, there is also no danger of inadvertently drilling into utility lines (power, water, etc.) running under the plaster.

Furthermore, the device has the advantage that while its rack-like construction with a base element and a retaining element allows the attachment of upper and lower kitchen elements to an individual structural member. A measurement-accurate installation of the individual kitchen elements is thereby guaranteed, as well as the precise arrangement of the upper and lower kitchen elements parallel to one another. When the devices according to the invention are fitted with the kitchen elements concerned and are installed laterally side by side and in front of the kitchen wall, a high measurement accuracy is also produced over the entire width of the kitchen unit, in the sense that the lower kitchen elements and the upper kitchen elements are arranged at exactly the same height.

Moreover it is possible, as an advantage, for one device according to the invention, to install not just one upper kitchen element, but two or more upper kitchen elements, which indeed requires a sufficient width of the device. This likewise holds true for the installation of more than one lower kitchen element on the base element of the device.

By means of the device, the restrictions described at the beginning on placement of kitchen appliances are also avoided. The kitchen layout is also not bound to the location of the wall connections for power, water, gas, and so on. An alternative arrangement of individual kitchen appliances is thereby possible (dishwasher/sink, stove, refrigerator). In addition, the electric stove can perhaps be installed in any desired position inside a kitchen unit. The power-supply line connections are thereby available at the appropriate outlet location in the kitchen wall.

In this way also the problem is resolved, for example, in which, following the removal of the structural member of an already provided kitchen arrangement in a new house due to the lowermost different locations of power and water connections in the kitchen wall, the corresponding utility lines have to be laid over again. For the reason that the device or several devices installed side by side in a row according to the invention can even be installed when they are not very far away (for example, approximately 5 to 10 cm) from the kitchen wall, it is possible, with no difficulties, to connect the concerned utility lines in the remaining free space between the retaining element of the device and the kitchen wall from the wall connections to the connection locations concerned in the kitchen unit. This also holds true for upper and lower kitchen elements. In this way, the device according to the invention is suitable for both old buildings and new construction. Consequently it is sufficient to provide a single electrical outlet in the kitchen wall, with additional outlets able to be connected if desired. The installation of a tile panel on the kitchen wall is not necessary. In general, the wall material is not damaged when the device according to the invention is used. Thus the original state of the kitchen wall remains as-is, so that in dismantling the kitchen, for example due to moving from a house, no additional work to the kitchen wall is required.

Additionally, the advantage is offered that the position and number of outlets for utilities and counter lights in the kitchen installation can be freely chosen, because the outlets and counter lights above the power lines, which are in the area behind the device according to the invention, are made with the kitchen elements connected to the applicable power outlet in the kitchen wall.

The previously mentioned gap between the retaining element of the device of a kitchen unit and the kitchen wall need only be large enough for the utility lines or cable at the location. This interspace can be closed from above at the upper end of the device or its retaining element, by means of an appropriate cover cut out. This is similarly true for the lateral openings in the kitchen unit.

Finally, the invention is advantageous for short people, who have small-sized kitchen elements available to them in the marketplace. Such kitchen elements can likewise be installed without problems for devices according to the invention and certainly independently of the situation for the applicable kitchen wall, such as the height of the tile panel. In the dependent claims are the advantageous embodiments of the device according to the invention.

According to a first embodiment of the invention, the base element and the retaining element are of the same width. This allows the installation on the device of an upper and lower kitchen element of the same width. This is probably the usual case. According to the invention, the same width for base element and retaining element is certainly not obligatory. Thus the device can, for example, be built with a base element that is wider than the retaining element.

In this connection, it may be noted from this that a device according to the invention also allows one single installation for a kitchen element on the base element which is relatively tall, for example a tall refrigerator-freezer combination, which is sometimes approximately two meters high. In this case, no upper kitchen element is also attached to the retaining element of the device.

According to a second embodiment of the invention, the retaining element of the device is constructed as being adjustable for height, so that the height at which the kitchen element or elements is or are attached to the retaining element, can be changed. Thus it allows the advantage that the upper kitchen element(s) of the three-dimensional factor or the personal needs of the kitchen users is or are accordingly installed up high. In this way, an upper kitchen element can be attached lower down for short or small people. The same holds true for disabled persons (for example wheelchair users), who could not otherwise reach a needed high or hanging cupboard by hand by themselves. However, when the installed kitchen is later sold to taller people, they can, with a similar device, and without further measures, execute a higher installation for the upper kitchen element.

According to a further preferred embodiment, in the upper and/or lower area of the retaining element of the device according to the invention, means are provided for attaching or passing utility lines through to the rear, such as, for example, water-supply or wastewater lines, power lines, and/or gas lines. By using this attachment means, a safer, purpose-built laying of such utility lines is possible along the back side of the kitchen installation from the related wall outlets to the related appliance connections.

Furthermore, it is possible as an advantage, in the middle area of the retaining element of the device according to the invention, to provide means for installing a kitchen rear-wall panel between the upper and lower kitchen elements. In this way, without additional preparations to the kitchen wall, that is, for example, without introducing or using a tile panel, to also install a prepared kitchen rear-wall panel simply for the device according to the invention. In this way, there results a neater and more visually appealing solution to covering the open area between the upper and lower kitchen elements. This also holds for kitchens for small people (see above). Moreover a kitchen rear-wall panel has the advantage that it can be readily replaced without disassembly of the kitchen element, and certainly, for example, for aesthetic or functional reasons (when, for instance, a new location for the outlets is desired).

With this, when it is shown as being appropriate, the kitchen rear-wall panel installation can use a transparent material, a translucent, or a partially translucent material instead of a nontranslucent material. In this case, light that a light source emits behind the kitchen rear-wall panel, for example, directed toward the kitchen wall, can shine through the kitchen rear-wall panel to the worktop. For any repairs to such a light source, an inspection flap in the kitchen rear-wall panel may be provided. The partially translucent kitchen rear-wall panel may be a milk-glass pane or may consist of a stained glass material.

According to a preferred embodiment of the invention, openings are provided in the kitchen rear-wall panel for inserting container-holders, for example, for spices, knives, or other kitchen utensils. Such container-holders can also be pulled out using an adjustable turning or rotating part.

In claims 8 to 20 below, additional advantageous embodiments of the invention are presented, in which the retaining element, in essentially two similar heights, consists of section rails running vertically and laid out, depending on the width, parallel to one another. For a greater width, the device or the retaining element can also be used for stability purposes with more than two section rails. With respect to finished-product engineering, the section rails can be advantageously manufactured of rectangular pipe. Such rectangular piping also exhibits, for a rather small cross-section, high resistance to bending, so that the retaining element does not have to be very heavy in order to support the heavy loads attached to it. A metal such as steel or aluminum is suitable as a material for the rectangular piping.

In this connection, it may be noted that an altogether suitable rack-like device of the invention may be manufactured out of metal, either steel or aluminum.

In addition, the device can, for instance, be manufactured to be dismantled for transport and positioning purposes, in which the retaining element and the base element are not of one piece, meaning they would be inextricably connected together, but are two individual parts set together on a device according to the invention (for example, by means of a plug connection) and can be separated later if necessary. Dismantling of the device into both of the individual “base element” and “retaining element” portions can also involve folding the elements together for transport or positioning purposes.

In a further embodiment of the device according to the invention, at least one utility-line connection panel is provided for attaching or passing utility lines therethrough which extends into the upper and/or lower area of the base element between the left and right section rails, in the case of two section rails. The preference is that the utility-line connection panel has at its front side connection supports or other appropriate means for at least one hot and one cold water-supply line and/or one opening for at least one wastewater/sewer line. In this way, a safer attachment or passage for the utility line is guaranteed.

An advantage is that, in the upper and/or lower area of the retaining element toward the back side of the section rails, brackets are additionally installed for connecting utility lines along the back side of the device or the total kitchen installation.

To fasten at least one upper kitchen element, the invention provides in a further advantageous refinement that the section rails in the area of their upper end are connected by means of a brace-like support member. An upper kitchen element can be easily mounted on or dismounted from this support member, for which different attachment means are possible. According to one advantageous refinement of this embodiment of the invention with a support member, this support member has an L-shaped cross-section, so that its first leg is fastened onto the front side of the upper end of the section rail and the second leg lies at its upper end. At least one L-shaped angled retaining member is installed at the back of the upper side of at least one kitchen element, with the first leg of the L-shaped angled retaining member fastened to the back of the upper side of the kitchen element, while the second free leg of the L-shaped angled retaining member is directed downwardly behind the second leg of the support member to suspended and support the kitchen element, with the back side of the kitchen element against the first leg of the support member. Aside from this, another advantageous arrangement of the invention is provided, such that in the upper area of the section rail of the device, for supporting the rear underside of the upper kitchen element(s) and for simultaneously installing the upper horizontal side corner of a kitchen rear-wall panel, a flange-like retaining brace with an L-shaped cross-section extends horizontally between the section rails, and/or such that in the lower area of the section rail for holding the rear upper corner of the lower kitchen element(s) and for simultaneously supporting the lower horizontal side corner of the kitchen rear-wall panel, a flange-like retaining brace with an L-shaped cross-section extends horizontally between the section rails, whereby a leg of the retaining brace(s) is installed at the front side of the section rails and the other horizontal leg of the retaining brace(s) projects forward. This refinement of the invention makes possible an especially stable element and of sufficiently good fit or weight for installation of the upper or lower kitchen elements.

In an advantageous refinement of the aforementioned embodiment with retaining braces, these have a double L-shaped cross-section, at the front of which a free leg points upward or downward, so that the kitchen rear-wall panel is flanked by both of these front legs on its front side.

According to a further embodiment of the device according to the invention, each section rail exhibits on its front side of the device on the side concerned a vertically running slot over its entire length for the height-adjustable attachment of the utility-line connection panel, the support member, and/or the retaining brace(s). This embodiment with a vertically running slot in each section rail make possible an individual setup or introduction of the afore-mentioned structural members and thereby also of the kitchen elements concerned with respect to its desired mounting height.

With the embodiment of the invention with section rails that exhibits a slot, an especially safe attachment of the upper kitchen element can be achieved by using a more flexible, swiveling arm installed at the rear end of an upper kitchen element, whereby at the outer end of the arm a nose-like projection is provided for attaching the kitchen element to the retaining element from the front by means of the slot in the applicable section rails to make a snap-catch connection, in which the projection extends behind the slot in engagement with one of the two front legs of the section rail. By moving the arm, an attached upper kitchen element can be easily removed again from the device, because the projection then disengages from the leg of the section rail.

In order to achieve different heights for the retaining element, section rails are used in a preferred embodiment of the invention, which consists respectively of at least two section rail parts, which are set inside one another for purposes of height adjustment and are telescopically constructed to be movable in and out. Thus, these are a means for stopping the section-rail parts at the desired position, that is, they provide the desired height.

With this embodiment, in the case of the section-rail parts which are constructed out of rectangular pipe, drill holes can be provided for stopping, whereby the holes of the section-rail parts set inside one another are moved in pairs over one another so that a security rod, a security screw, or the like can be set in through the aligned holes. Such a telescoping technique is also well-known in other expert fields, so that no further clarification is needed here. The aforementioned holes or another suitable means can similarly accomplish the purpose, such as two adjoining devices according to the invention with screws to connect them together detacably.

A further embodiment provided for the invention exhibits in the base element a square or rectangular installation surface for at least one lower kitchen element, in which from the four corners of this installation surface four support legs of equal length extend vertically downward. Thus there is a gap from the kitchen floor to the underside of the lower kitchen element, which is especially advantageous for cleaning purposes. The space between the lower kitchen element and the kitchen floor can also be closed by means of a door.

It may be noted from this that a device according to the invention can also exhibit a base element that does not have a square or rectangular installation surface, but is an installation surface with another shape. This may, for example, be sensible for a device according to the invention that is laid out in the corner of a kitchen. In this case, the device may also display only these support legs (two in back and one in front).

For adequate setup or adjustment of the device of the invention horizontally, it is an advantage to provide a means for adjusting the height of the support legs. For this purpose, the usual means are known. It may be noted at this point that for constructing a kitchen, the corresponding devices of the invention are preferentially first installed side by side at the location provided and are adequately set up, in which the height of the support legs is adjusted as needed. Then the kitchen elements are installed on the devices.

Furthermore it is after all not an advantage on the basis of finished engineering when the rear support legs of the base element are constructed by the lower ends of the section rails.

Moreover it is conceivable to install rollers beneath the support legs of the base element, so that the device can be moved by rolling. This then is above all advantageous, and certainly when the device is already fitted with kitchen elements and of high weight.

Finally the invention provides a manufactured kitchen unit by using the devices according to claims 1 to 27, in which the devices are laid out laterally side by side. Thus respectively adjoining devices can be connected by suitable means to one another (for example, by screws), whereby the kitchen unit stands altogether stably. For such a connection, the holes required can be provided in the lateral legs in section rails made of rectangular pipe.

The device according to the invention is moreover suitable for constructing kitchen units with different foundations or geometries. Thus several independent devices can be side by side, that is, built in a line. Such a kitchen unit allows installation to or in front of a kitchen wall. In place of this, such a kitchen unit can also be installed in the middle of a room. If need be, it is recommended for visual reasons that the rearward side of this kitchen unit set together by the devices be covered up by a suitable means. In this case, when devices according to the invention are used to construct a portion of a room, the installation of upper or hanging cupboards is still possible, because this installation is possible by use of the retaining element. Similarly in such a portion of the room, the usual items such as worktop, outlets, lighting, the rear kitchen wall, etc. can be executed without constructing a complicated divider or rear wall.

The devices of the invention can be used to provide a linear kitchen unit along a wall that is not straight (have projections or recesses in the wall), since the units can pass over such areas.

It is self-evident of course, that in using the devices according to the invention, a kitchen installation shall have the appropriate devices built into a room corner, so that the kitchen has, for example, an L-shape. A U-shaped kitchen foundation is also possible.

Finally a device according to the invention can be built or set together for use with kitchen units in attic-level homes underneath a sloping ceiling, where upper cupboards could not heretofore be mounted. It also allows, based on the invention, for such kitchens to be provided with outlets and tile walls. In such a case there is also the possibility of constructing the retaining element at just low height, and this eliminates an upper kitchen element on the retaining element in the installation

Finally it is seen from this that the basis for the invention does not restrict the use of the kitchen installation. On the contrary, uses come up, such as for a cupboard or shelf system and the like.

The invention is further clarified as follows in the schematic drawings at hand.

The following are presented:

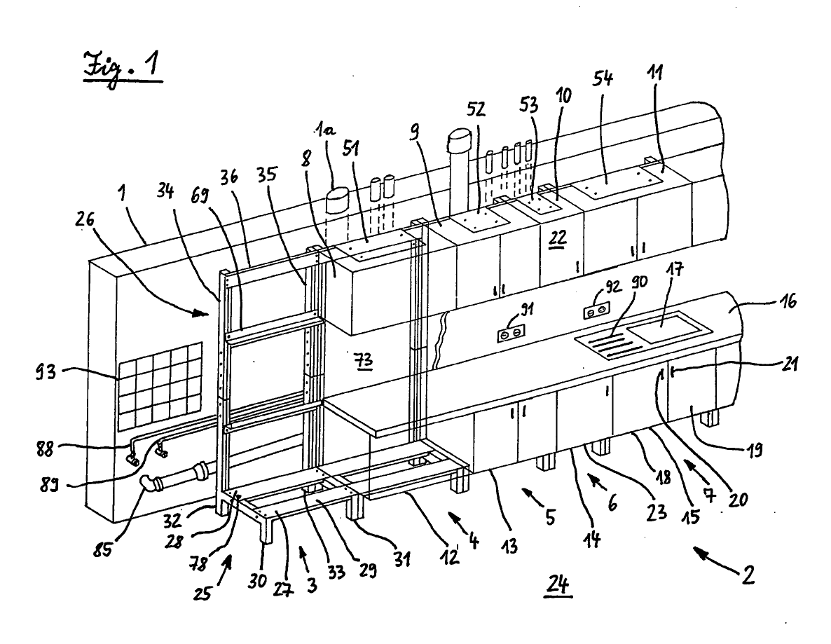

FIG. 1 a perspective view of the top of a kitchen installation consisting of several devices according to the first embodiment of the invention

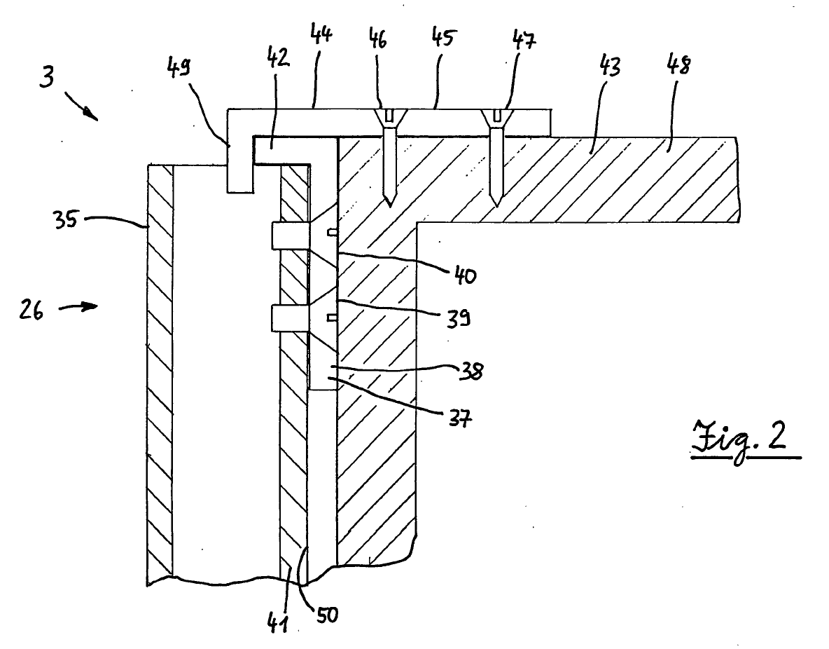

FIG. 2 a lengthwise sectional view of the upper end of the device in FIG. 1 without the kitchen elements shown, with a retaining member for attaching an upper kitchen element

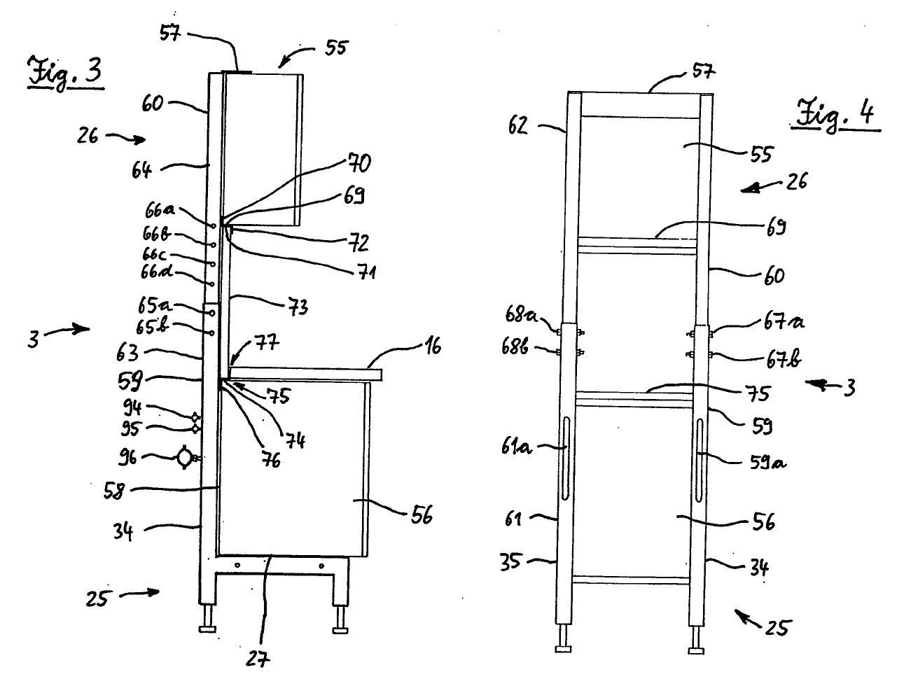

FIG. 3 a side view of the device according to FIGS. 1 and 2 (with kitchen elements installed thereon)

FIG. 4 a rear view of the device according to FIG. 3

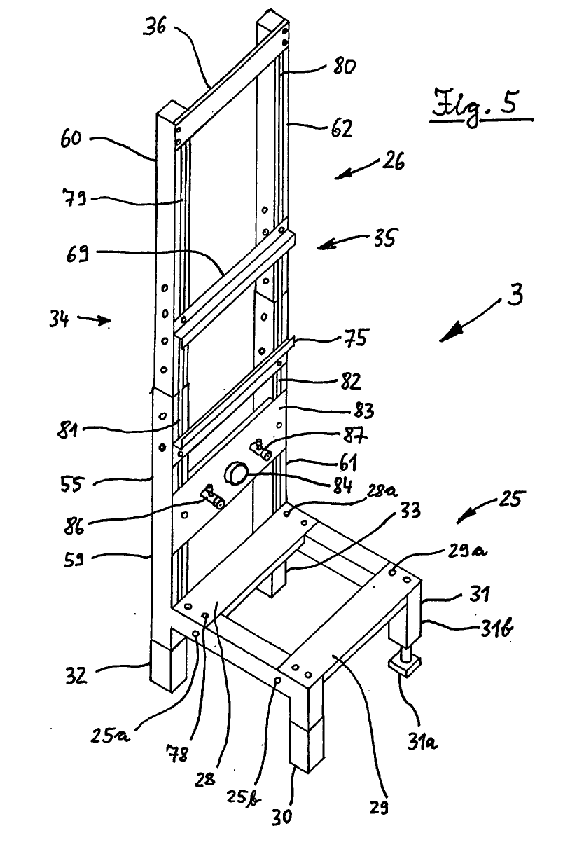

FIG. 5 a perspective view of the top of the device in FIG. 1, without kitchen elements shown, with a utility-line connection panel

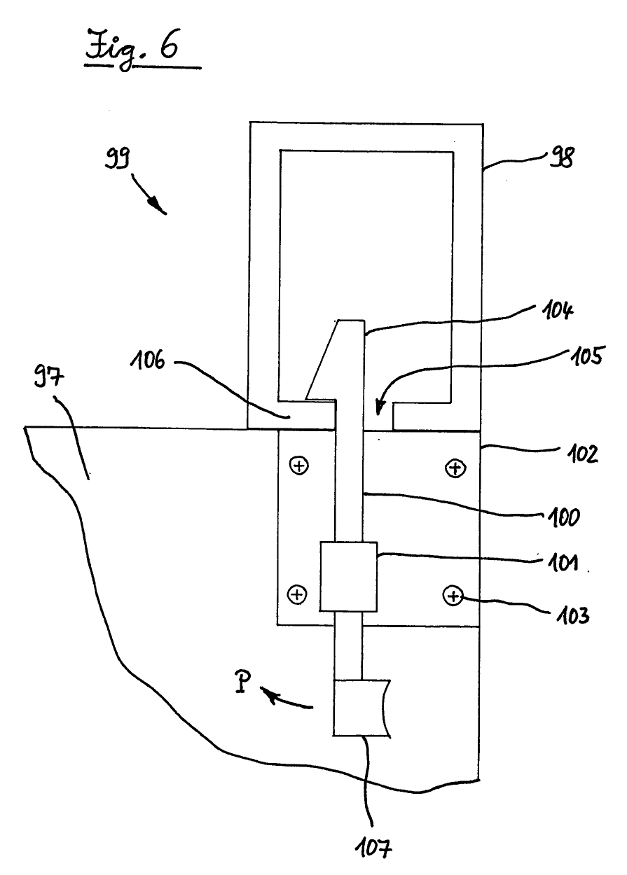

FIG. 6: a partial view from the top on the upper end of the section rail (with slot) of the retaining element of a further device according to the invention, as well as of an upper kitchen element installed on it by means of an attachment arm

FIGS. 7 to 10: four different arrangements for a kitchen consisting of devices according to the invention

FIG. 11: a sectional view from the side in a attic-level house with two further embodiments of the device according to the invention.

FIG. 1 shows a kitchen wall 1, in which water, wastewater, gas, and electrical lines 1a run vertically underneath plaster and in front of which is built a kitchen unit 2. This kitchen unit 2 consists of several devices according to the invention, installed side by side in a line, of which of course only the devices 3 to 7 are represented in FIG. 1. Thus the device 3 is in the view according to FIG. 1 at the far left and the device 7 at the far right. In between, the devices 4, 5, and 6 are in a row from left to right.

The device 3 is represented for illustration, with the described embodiment according to the invention, without kitchen elements attached to it. At the bottom right are indicated the devices 4 to 7 with upper kitchen elements 8 to 11 attached to it, as well as lower kitchen elements 12 to 15. Thus the device 4 is shown only to better illustrate, so kitchen elements 8 and 12 do not cover up the angles of view for the device 4.

The lower kitchen elements 12 to 15 are covered by a worktop 16. In the area of the lower cupboard 15 a sink 17 is installed in the worktop 16. In the kitchen unit 2 shown in the Fig. section, no kitchen stove, oven, or refrigerator is provided. These appliances may however stand independently, for example, as installed on the devices 3 and 4 or on the right of the device 7.

The lower kitchen elements 13 and 15 are lower cupboards, which can be opened or closed in a known manner by means of two laterally closing doors. An example of this is the case of the lower kitchen element 15, that is, the lower cupboard 15, which has on the left the lower cupboard door 18 and on the right the lower cupboard door 19, with doorknobs 20 and 21.

The lower kitchen elements 12 to 15 have respectively the same width as the corresponding upper kitchen elements 8 to 11 attached to the same devices 4 to 7. Like the lower cupboards 13 and 15, the upper cupboards are treated as the upper kitchen elements 9 and 11, which on their front side respectively are closed by means of two doors. Between the upper kitchen elements, that is the upper hanging cupboards 9 and 11, is an upper cupboard 22 built onto the device 6 and beneath it a corresponding lower cupboard 23 built onto the same device 6. It is evident from FIG. 1 that the upper cupboard 22 and the lower cupboard 23 of the device 6 are built to be narrower than the upper cupboards 9 and 11 or the lower cupboards 13 and 15 which are laid out on the left and right side by side. Consequently, the devices 3 to 7 represented in FIG. 1 differ in width. But the devices 3 to 7 however have a similar construction.

The construction method for the devices 3 to 7 will be clear from the following description, based on the example in FIG. 1, of device 3 without the kitchen elements provided being shown.

The device 3 includes one base element 25 standing on the kitchen floor 24 for the installation of a lower kitchen element, as is the case of all the devices 4 to 7 of the lower kitchen elements 12 to 15. At the rear end of the base element 25 is a retaining element 26 indicated as extending vertically upward. In the upper area of this retaining element 26 are provided adjoining means to be described later for attaching an upper kitchen element, as the upper kitchen elements 8 to 11 in the devices 4 to 7. The base element 25 has a rectangular installation surface 27 for the lower kitchen element of the device 3 that is not represented in FIG. 1. The installation surface 27 is constructed on two support plates 28 and 29, which are at a distance, for instance of 10 cm, from the floor and are fastened to the base element 25 with screws 28a or 29a. The base element 25 of the device 3 additionally contains four metal support legs 30 to 33, which extend downward from the four corners of the installation surface 27. The support legs 30 to 33 are of equal length and make possible a more secure position for the rack-like device 3.

The retaining element 26 at the rear of device 3, that is, on the applicable side of device 3 toward the kitchen wall 1, consists of two equally tall, vertically running section rails 34 and 35 laid out parallel to one another and corresponding to the width of the retaining element 26. These section rails 34 and 35 exhibit a distance that corresponds to the distance between the left-hand support legs 30, 32, and the right-hand support legs 31, 33, of the base element 25. In other words, the retaining element 26 and the base element 25 are of equal width. The section rails 34 and 35 are constructed from rectangular pipe. They are connected in the area of their upper ends, not shown in FIG. 1, to attach the upper kitchen element of the device 3 by means of a support member 36.

There are various possibilities for attaching an upper kitchen element to the support member 36. One possibility is shown in FIG. 2 and is described below.

FIG. 2 thus shows a support member 37, that is attached to the section rails 34 and 35, of which only the right-hand section rail 35 is shown. The support member 37 is therefore quite different from the support member 36, such that the support member 37 exhibits a first leg 38, which is attached with screws 39 and 40 to the upper end of the forward slot 41 of the section rail 35, while the second leg 42 exhibits the L-shaped construction of the support member 37 at the upper end of the section rail 35. In addition, FIG. 2 shows that, on the upper side and on the back end of an only partially shown upper kitchen element 43, an L-shaped, angled retaining member 44 is installed. Its first leg 45 is, with screws 46 and 47, attached to the upper side, that is, to the cover plate 48 of the upper side of the kitchen element 43. On the other hand, the second free leg 49 of the L-shaped angled retaining member 44 is directed vertically downward, so that it supports in suspended position kitchen element 43, which is shown in FIG. 2, to the second leg 42 of the support member 37. At the same time, the rear wall 50 of the kitchen element 43 joins the first leg 38 of the support member 37. This hanging attachment is also possible by simple means, such as by simply mounting the upper kitchen element to the upper end of the retaining element 26 in order to hang down. Thereby the upper kitchen element 43 does not have to be attached to the kitchen wall 1 by means of screws.

Corresponding to the attachment technique shown in FIG. 2 for an upper kitchen element 43 with a retaining member 44, the retaining members 51 to 54 are seen from FIG. 1 on the upper side of the upper kitchen elements 8 and 11. Corresponding to the width of the upper kitchen elements 8 and 11, the retaining members 51 and 54 are wider than the retaining member 52 of the upper kitchen element 9, while the retaining member 53 of the upper kitchen element 10 is narrower.

FIG. 3 again shows the device 3 with a base element 25 and the retaining element 26 in a view from the left side. For this, in contrast to FIG. 1, an upper kitchen element 55 and a lower kitchen element 56 are represented in FIG. 3. The upper kitchen element 55 is attached to the retaining element 26 with a retaining member 57 attached on the upper side. The lower kitchen element 56 is installed against the installation surface 27 of the base element 25, and the rear wall 58 of the lower kitchen element 56 lies on the front side of the section rails 34, 35. In FIG. 3 only the left section rail 34 is displayed. FIG. 4 shows the device 3 from the rear, so that the left section rail 34 and the right section rail 35 are to be seen. In FIG. 4 the retaining member 57 of the retaining element 26 is also seen. FIG. 3 also shows the worktop 16 installed on the lower kitchen element 56.

The retaining element 26 displays section rails 34 and 35, which consists respectively of two section-rail parts, namely the left-hand section rail 34 made of section-rail parts 59 and 60 and the right-hand section rail 35 made of the section-rail parts 61 and 62 (FIG. 4). The special feature of these section-rail parts 59 to 62 consists of the fact that they are constructed for the height adjustment of the retaining element 26 while they are set respectively inside one another and are telescopically movable in and out. This means that the upper section-rail part 60 is placed in the lower section-rail part 59 of the left section rail 34, while the upper section-rail part 62 is placed in the lower section-rail part 61 of the right-hand section rail 35.

In the lateral slot 63 of the lower section-rail part 59, two holes 65a and 65b are provided, while in the corresponding lateral leg 64 of the upper section-rail part 60 six holes 66a to 66f are provided. Thus both of the lower holes 66e and 66f in FIG. 3 are not seen, because the related part of the upper section-rail part 60 is placed in the lower section-rail 59 and is covered by it, and indeed so that the holes 65a and 65b, like the holes 66e and 66f are respectively moved over one another and line up so that two security screws 67a and 67b are put through and can be screwed down. Correspondingly, this holds true for the right-hand section rail 35, for the security screws 68a and 68b shown in FIG. 4 at the same height as the screws 67a and 67b.

This construction for the retaining element 26 with section-rail parts 59 to 62 which are telescopically movable in and out makes it possible to change the height of the upper kitchen element 55. Also when the upper kitchen element will be hung somewhat lower, only the security screws 67a and 67b, as well as 68a and 68b, have to be loosened or moved aside and the upper section-rail parts 60 or 62 corresponding to the desired height reduction moves lower down the applicable number of holes, that is, it sinks more deeply into the lower section-rail parts 59 and 64 described. The reverse allows the suspension height of the upper kitchen element 55 to be moved upward in a problem-free manner. This is moreover seen in FIGS. 1 as well as 3 and 4, that for support the rear lower corner or the underside of the upper kitchen element 55, a more flange-like retaining brace 69 is installed between the section-rail parts 60 and 62, in which this retaining brace 69 is attached as a gusset with a double L-shaped (or Z-shaped) cross-section. Thus the upper leg 70 is attached onto the front side of the upper section-rail part 60 or 62. The middle leg 71 runs horizontally and serves thereby to support the rear underside of the upper kitchen element 55. The front or lower free leg 72 of the upper retaining brace 69 points down-ward and consequently includes the horizontal upper side corner of a kitchen wall panel 73 (see FIG. 3).

On its lower horizontal side corner lies a kitchen rear-wall panel 73 at the middle leg 74 of a likewise double L-shaped retaining brace 75. This lower retaining brace 75 is similar to the upper retaining brace 69 on the section rails 34 and 35, and are indeed attached to the lower section-rail parts 59 and 61. Thus however the leg 78 attached on the front side of the section-rail parts 59 and 61 points downward and the front, free leg 77 of the lower retaining brace 75 points upward, the latter therewith includes the kitchen rear-wall panel 73 on its front side in the area of the lower corners. The leg 77 of the gusset-shaped retaining brace 75 likewise serves as an installation surface for the rear side corner of the worktop 16. The rear upper corner of the lower kitchen element 56 moreover includes the middle leg 74 of the lower retaining brace 75. Thus, the upper retaining brace 69 and the lower retaining brace 75 prevent tipping of the upper kitchen element 55 and the lower kitchen element 56. The upper retaining brace 69 thereby relieves the retaining member 57 of loading at the upper end of the retaining element 26. In this connection, it is said that the lower kitchen element 56 can be included for fixing or fastening to the base element 25 on the underside, for example, by using rods, not shown. These rods can be placed in holes 78 (see FIGS. 1 and 5) of the installation surfaces 27 and 28 of the base element 25.

As is evident from FIG. 1, the section-rail parts 59 to 62 exhibit over their entire length four vertically running slots 79 to 82. To better illustrate this, these slots 79 to 82 are taken to be in accordance with the representation of the device 3 according to FIG. 5. Thus the slot 79 in the upper left section-rail part 60 and the slot 80 in the upper right section-rail part 62 are provided. However it also comprises the slot 81 in the lower left section-rail part 59 and the slot 82 in the lower right section-rail part 61. Because of the brace-like telescopic connection of the section-rail parts 59 to 62, the slots 79 and 81 provide a continuous slot in the left section-rail part 34 and the slots 80 and 82 provide a continuous slot in the right section-rail part 35. These slots 79 to 82 have the purpose of moving upward or downward the structural member installed on the retaining element 26, as well as the retaining members 36 or 37 and the retaining braces 69 and 75 (height-adjustable) and can then be attached at the desired height to the section-rail parts 59 to 62 by means of screws not otherwise shown. The support member 36 or 37 and the retaining braces 69 and 75 may also attached so as to require the applicable height of both the kitchen rear-wall panel 73 as well as the upper kitchen element 55 and the lower kitchen element 56. Moreover, the previously described construction of the retaining braces 69 and 75 with their double L-shaped cross-section has the advantage that the kitchen rear-wall panel 73 can be moved or pointed away from device 3 or back toward it.

FIG. 5 shows the device 3 according to FIGS. 1, 3, and 4, in which a utility-line connection panel 83 is installed in the lower area of the retaining element 26. The utility-line connection panel 83 is, like the support member 36 or 37 and the retaining brace 69 and 75, attached at its lateral ends with screws in the slots 79 to 82 of the section-rail parts 59 to 62 at the desired height adjustment. This screw-fastened attachment, not otherwise specified, may, for example, be executed in such a way that a screw is placed in the slot 82 of the lower utility-line connection panel 83 from the front through to the back in which, on the inside of the section-rail part 61 that is constructed of rectangular pipe, a secured nut is set which serves to prevent displacement.

The utility-line connection panel 83 has a previously mounted bushing 84 in an opening (made, for example, out of plastic) for a sewer pipe, which is not shown here, for a connection to a dishwasher or a sink by way of example. With this, a connection can be made between the wastewater outflow pipe of a dishwasher and the sewer pipe 85 running to the kitchen wall, as is seen in FIG. 1. Corresponding to this, angle valves 86 and 87 are provided in the utility-line connection panel 83 as connection supports on the left and right below the bushing 84. In this way the water pipes 88 and 89 represented in FIG. 1 are connected to the device 3 and the lower kitchen elements are set on it.

In FIG. 5 is seen an example of the front right-hand support leg 31 of the base element 25, for which a height adjustment is possible for a horizontal setup of the device 3. The support leg 31 includes for this a support foot 31a screwable up or down, which can be covered by means of a rectangular support-leg sleeve 31b of the desired height. In FIG. 5 the support-leg sleeve 31 is represented in a highly displaced condition. The support-leg sleeves corresponding to the other three support legs 30, 32, and 33 are moved downward toward the floor. For the kitchen installation, it is recommended that the device 3 and the adjoining devices first be installed without the kitchen elements, for example to the kitchen wall, and be precisely aligned, in which the opportunity to adjust the height of the support legs 30-33, for example, is extremely helpful. Then, the kitchen elements are mounted. By constructing the base element 25 of the device 3 with the installation surface 27, which is made up of both of the support plates 28 and 29, it is moreover very readily possible, by gripping by hand from above through the space between the support plates 28 and 29, to change the height of the rear support legs 32 and 33 to adjust them as needed.

In this connection, it is also noted that the device 3 shown in FIG. 5 on the left or right side of its base element 25 exhibits two holes 25a and 25b. These holes 25a, 25b serve to connect two devices standing side by side to operate for greater stability of the kitchen unit.

In addition, FIG. 1 shows, in the area of the lower kitchen element 15, the sink 17 with a side-board or drainage-board area 90, as well as two double outlets 91 and 92 in the area of the kitchen rear-wall panel 73. Moreover a tile panel 93 fitted to the kitchen wall 1 is shown in FIG. 1 to better illustrate this, which is, however, not required, due to the kitchen rear-wall panel 73.

FIG. 1 shows that the kitchen unit 2 is set up at a distance from the kitchen wall 1, so that between the retaining element 26 of the devices 3 to 7 and the kitchen wall 1a gap or intermediate space remains for the utility lines, as well as the water lines 88 and 89 and the sewer pipe 85. This is also true here for electrical power lines not shown.

In FIG. 3 finally two brackets 94 and 95 are shown for the water lines 88 and 89, as well as a somewhat larger bracket 96 for the sewer pipe 85, whereas neither the water lines 88 and 89 nor the sewer pipe 85 is shown in FIG. 3. In FIG. 4 it is seen that the lower section-rail parts 59 and 61 on their rear side exhibit a vertically running slot 59a or 61a for the height-adjustable attachment of the brackets 94-96. This opportunity for height adjustment is above all very advantageous for the sewer pipe 85.

In FIG. 6 another embodiment of an attachment solution is represented for an upper kitchen element 97. This kitchen element 97 is shown attached to the section rail 98 constructed from rectangular pipe, of a not otherwise represented retaining element for a device 99 according to the invention. Thus a more flexible, swiveling attachment arm 100 is installed on the upper side and on the rear end of the kitchen element 97. This attachment arm 100 is flexibly swivelable in a seat 101 in which this seat 101 is attached to an attachment plate 102, which once again is attached with screws 103 to the upper side of the kitchen element 97. The attachment arm 100 has a nose-like projection 104 on its outside end. This projection, whose geometry is seen in FIG. 6, is inserted from the front for attaching the kitchen element 97 by means of the slot 105 of the section rail 98 to make a snap-catch connection. Thus the projection 104 reaches behind the slot 105 in engaging the left front slot 106 of the section rail 98. When the upper kitchen element 97 will be removed again from the retaining element of the device 99, the attachment arm 100 merely has to be pulled toward its front end 107 to the left, that is, in the direction of the arrow “P” in FIG. 6. Thus the projection 104 disengages and can be moved away from the section rail 98. In the seat 101 is a reset spring, so that the attachment arm 100 is drawn again into operation in its initial state, that is it is pulled perpendicularly to the rear wall according to FIG. 6.

FIGS. 7 to 10 show different kitchen-space foundations or arrangements with different variants of kitchen installations or kitchen units, which are produced by changing the devices according to the invention. Thus, some of the possibilities for numerous uses of the invention are illustrated depending on the local situation and the personal needs of the kitchen users.

In FIG. 7 a kitchen installation 108 is first seen, which comprises two kitchen units 109 and 110. The first kitchen unit 109 consists of four devices 111a, b, c, and d according to the invention, which are installed in a line laterally side by side in front of a flat kitchen wall 112. In parallel in front of the first kitchen unit 109 or in the middle of the room is the second kitchen unit 110. This second kitchen unit 110 consists of four devices 113a, b, c, and d, which likewise stand in a line laterally side by side, so that the kitchen unit 110 also runs in a straight line.

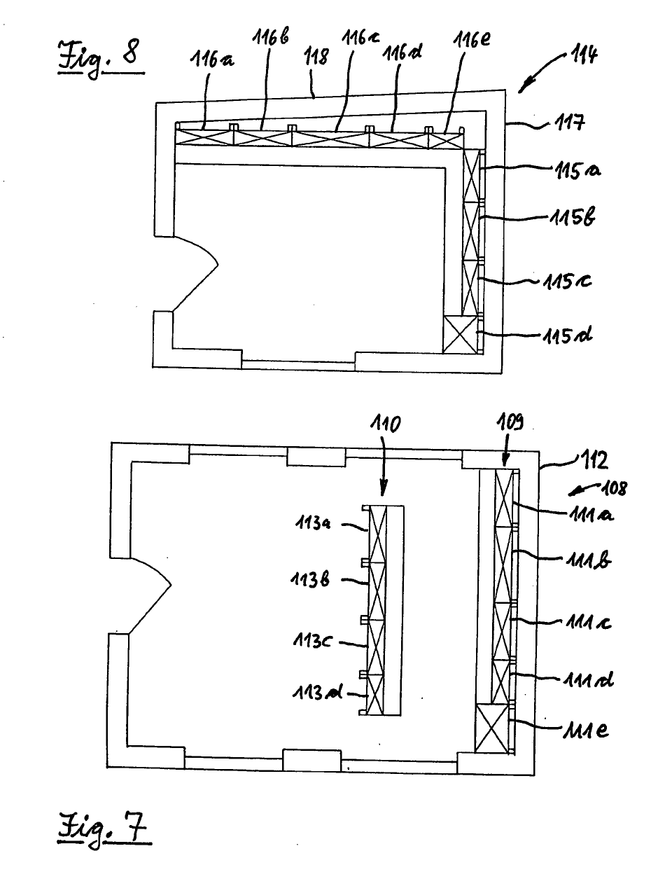

FIG. 8 illustrates a kitchen installation 114, which has an L-shaped construction, in contradistinction to the kitchen installation 108. Thus the first leg of the kitchen installation 114 is made up of the four devices 115a, b, c, and d according to the invention and which are of equal width. The device 115d supports, as does the device 111d in FIG. 7, a refrigerator or freezer in the corner of the room. The second leg in the kitchen installation 114 consists of the devices 116a, b, c, and d of different widths. Both legs of the kitchen installation 114 stand at right angles to one another, although the kitchen walls 117 and 118 running respectively to the rear form an angle of less than 90°. This shows that with the problem-free device according to the invention, even with a kitchen with irregular dimensions, that is, for example, non-squared kitchen walls, can be squared up.

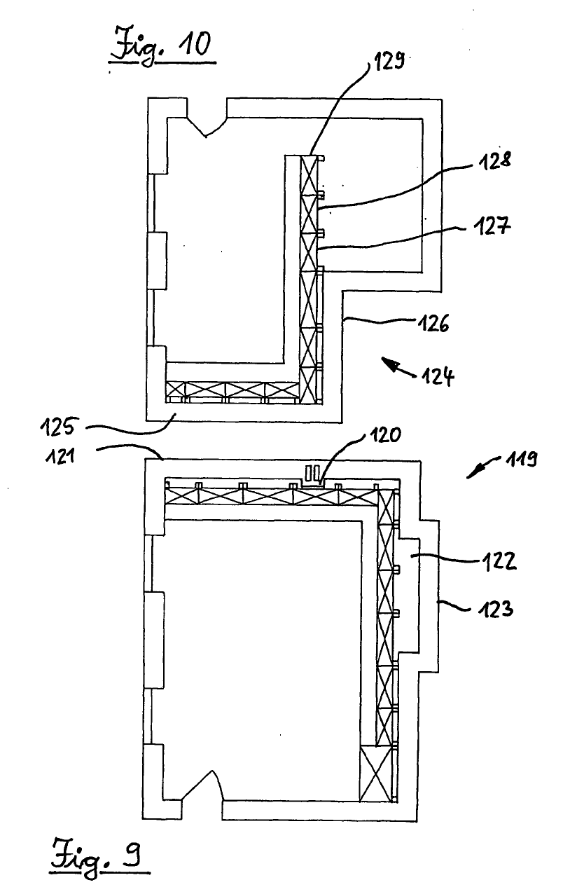

Like FIG. 8, FIG. 9 also shows a kitchen installation 119, which has an L-shape. FIG. 9 clarifies that the devices used to construct both legs in this kitchen installation 119 can even square up unevenness in the kitchen walls. So a leg in the kitchen installation 119 for the projection 120 (for example, due to a chimney) can be bypassed in the kitchen wall 121. Apart from that, the other legs of the kitchen installation 119 covers the clearance 122 in the other kitchen wall 123.

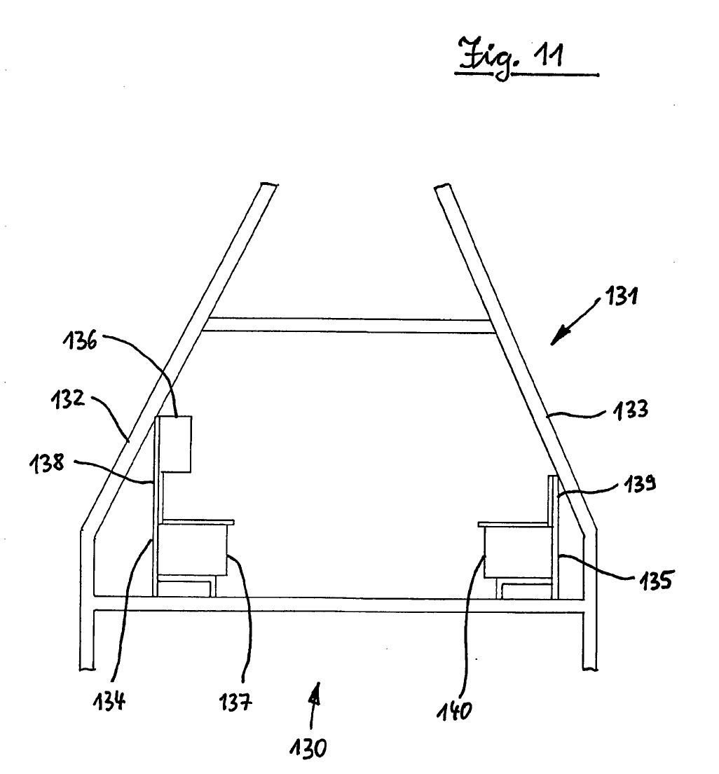

FIG. 10 shows a kitchen installation 124, also installed in a L-shape. While a leg of this kitchen installation 124 lines up at the kitchen wall 125, the other leg runs along the kitchen wall 126. The special feature of this consists of the fact that this other leg is longer than the kitchen wall 126, so that the devices 127, 128, and 129 relating to this leg point inward into the kitchen. This free end of the leg for the kitchen installation 124 thus have in a certain way the function of the portion of a room.

Finally, FIG. 11 comprises a kitchen installation 130 in an attic-level home 131 with a left-sloping ceiling 132 and a right-sloping ceiling 133.

In order to show that the invention is also suitable for such an attic-level home 131, FIG. 11 shows a device 134, which is installed for the sloping ceiling 132 and at some distance from it. On the right side in FIG. 11, the device 135 for the sloping ceiling 133 may be seen. Unlike the traditional kitchen installation, the device 134 can, despite the sloping ceiling 132, take on an upper kitchen element 136 and a lower kitchen element 137. It however has to be assumed in the purchase that the device 134 is to be installed in one of the corners of the sloping ceiling 132 at an appropriate distance from it. By doing this, this distance remains as small as possible. The retaining element 138 of the device 134 for such a purpose is at a lower height, so that the upper kitchen element 136 is somewhat lower than it usually hangs. Here use can be made of the possibility described above of the retaining element 138 being executed as height-adjustable, in that it consists of section-rail parts that fit inside one another and are telescopically movable in and out.

As an alternative, the retaining element 139 of the device 135 is constructed in a shortened way, so that the device 135 can be moved proportionately near to the sloping ceiling 133. In this case, the attachment of an upper kitchen element is ruled out entirely and only a lower kitchen element 140 is attached to the device 135.

1. The invention concerns a device for installing kitchens that consists of kitchen elements, such as lower cupboards, upper cupboards, shelves, kitchen appliances, a worktop, a sink, and so on, characterized in that the device (3-7, 99, 111a-e, 113a-d, 115a-d, 116a-e, 127-129, 134-135) exhibits a base element (25) standing on the floor for the installation of at least one of the lower kitchen elements (12-15, 56, 137, 140), such as a lower cupboard, a sink (17), a kitchen stove and oven, a refrigerator, a dishwasher, a washing machine, and/or the like, and which is attached vertically at the back end of the base component (25) to the retaining element (26,138, 139) extending upward, in whose upper area means are provided for attaching at least one upper kitchen element (8-11, 43, 55, 97, 136), such as an upper cupboard, a hanging cupboard, a fume exhaust hood, and/or the like.

2. A device according to claim 1, so characterized that the base element (25) and the retaining element (26, 138, 139) are of the same width.

3. A device according to claim 1, so characterized that the retaining element (26, 138, 139) is constructed as being adjustable for height, so that the height at which the upper kitchen element(s) (8-11,43,55,97, 136) is/are attached to the retaining element (26, 138, 139), can be changed.

4. A device according to claim 1, so characterized that in the upper and/or lower area of the retaining element (26, 138, 139) means are provided for attaching or passing utility lines, such as, for example, water-supply or wastewater lines, power lines, and/or gas lines along the back side of the kitchen installation.

5. A device according to claim 1, so characterized that in the middle area of the retaining element (26, 138, 139) means are provided for inserting a kitchen rear-wall panel (73) between the upper and lower kitchen components (8-11,43,55,97, 136; 12-15, 56, 137, 140).

6. A device according to claim 5, so characterized that the kitchen rear-wall panel (73) is provided, made of transparent or partially translucent material for the passage of light that a light source located behind the kitchen rear-wall panel (73) emits.

7. A device according to claim 5, so characterized that in the kitchen rear-wall panel (73) selective openings are provided for the installation of container-holders for spices, knives, or other kitchen tools.

8. A device according to claim 1, so characterized that the retaining element (26,138,139) consists of section rails (34, 35, 98) in essentially two equal heights, running vertically, and laid out, depending on its width, parallel to one another.

9. A device according to claim 8, so characterized that the section rails (34,35,98) are constructed from rectangular pipe.

10. A device according to claim 8, so characterized that for attaching or passing utility lines through, such as water-supply or wastewater lines, power lines, and/or gas lines, at least one utility-line connection panel (83) is provided, which extends into the upper and/or lower area of the retaining element (26, 138, 139) between the left and the right section rails (34, 35, 98).

11. A device according to claim 10, so characterized that the utility-line connection panel (83) has at its front side connection supports for at least one hot and one cold water supply line and/or one opening for at least one wastewater line.

12. A device according to claim 8, so characterized that in the upper and/or lower area of the retaining element (26, 138, 139) toward the rear side of the section rails (34, 35, 98) brackets (94-96) are installed for connecting the utility lines, such as water-supply or wastewater lines, power lines, and/or gas lines along the back side of the kitchen installation.

13. A device according to claim 8, so characterized that the section rails (34, 35, 98) in the area of their upper end are connected by means of a brace-like support member (36, 37) for fastening at least an upper kitchen element (8-11, 136; 43, 55, 97, 136).

14. A device according to claim 13, so characterized that the brace-like support member (37) has an L-shaped cross-section, so that the first leg (38) of the angled support member (37) is attached to the front side and to the upper end of the section rails (34, 35, 98) and the second leg (42) is supported on the upper end of the same, and that at least one L-shaped, angled retaining member (44) is attached to the upper side and to the rear end of an upper kitchen element (43), in which the first leg (45) is itself attached to the upper side of the upper kitchen element (43), while the second free leg (49) of the retaining member (44) is directed downward and is buttressed in the hanging position of the upper kitchen element (43) to the second leg (42) of the support member (37), in which the rear wall of the kitchen element (43) is joined to the first leg (38) of the support member (37).

15. A device according to claim 8, so characterized that in the upper area of the section rail (34, 35, 98), for supporting the rear lower corner of the upper kitchen element(s) (8-11, 43, 55, 97, 136) and for simultaneous installation of the upper horizontal side corners of a kitchen rear-wall panel (73), a flange-like retaining brace (69) with an L-shaped cross-section extends horizontally between the section rails (34, 35, and 98) and/or that in the lower area of the section rails (34, 35, 98), for holding the rear upper corner of the lower kitchen element(s) (12-15, 56, 137, 140) and for the simultaneous supporting of the lower horizontal side corner of the kitchen rear-wall panel (73), a flange-like retaining brace (75) with an L-shaped cross-section extends horizontally between the section rails (34, 35,98), in which a leg (70, 76) of the retaining brace(s) (69, 75) is installed on the front side of the section rails (34, 35, 98) and the other horizontal leg (71, 74) of the retaining brace(s) (69, 75) project toward the front.

16. A device according to claim 15, so characterized that the upper retaining brace (69) and/or the lower retaining brace (75) have/has a double L-shaped cross-section and are/is so installed on the section rails (34, 35, 98) that the front, free leg (72) of the upper retaining brace (69) point downward or the front, free leg (77) of the lower retaining brace (75) point upward so that the kitchen rear-wall panel (73) is covered by both of these provided legs (72, 77) on their front side.

17. A device according to claim 8, so characterized that each section rail (34, 35, 98) exhibits on its front side of the device (3-7, 95, 111a-e, 113a-d, 115a-d, 116a-e, 127-129, 134-135) on the side concerned over its entire length a vertically running slot (79-82) for the height-adjustable attachment of a utility-line connection panel (83), supporting members (36, 37), retaining brace(s) (69, 75), and/or the like.

18. A device according to claim 17, so characterized that at the upper side and to the rear end of the upper kitchen element(s) (97) is installed at least one more flexible, swiveling attachment arm (100), at whose outer end a nose-like projection (104) is provided, which is introduced for attaching the kitchen element (97) to the retaining element (26) from the front by means of a slot (105) of the applicable section rail (98) to make a snap-catch connection in which the projection (104) runs behind the slot (105) in engagement with one of the two front legs (106) of the section rail (98).

19. A device according to claim 8, so characterized that the section rails (34,35,98) consist respectively of at least two section-rail parts (59-62), which are constructed for the height adjustment of the retaining element (26, 138, 139) being set inside one another and are telescopically movable in and out, whereby means are provided for stopping the section-rails parts (59-62) at the desired position.

20. A device according to claim 19, so characterized that each section-rail part (59-62) exhibits on its front side of the device (3-7, 99, 111 a-e, 113a-d, 115a-d, 116a-e, 127-129, 134-135,) over its entire length a vertically running slot (79-82) for the height-adjustable attachment of a utility-line connection panel (83), support member (36, 37), retaining brace(s) (69, 75), and/or the like.

21. A device according to claim 19, so characterized that in the lateral slots of the section-rail parts (59-62) constructed as rectangular piping holes (65a-b, 66a-f) are provided for stopping, whereby the holes (65a-b, 66a-f) of the section-rail parts (59-62) placed in pairs mover over or inside one another, so that a security rod, a security screw (67a-b, 68a-b), or the like can be set in through the aligned holes (65a-b, 66a-b).

22. A device according to claim 1, so characterized that the that the base element (25) exhibits a square or rectangular installation surface (27) for at least one lower kitchen element (12-15,56,137,140), in which four support legs (30, 33) of equal length extend from the four corners of the installation surface (27) vertically downward.

23. A device according to claim 22, so characterized that the support legs (30-33) for the horizontally adjustment of the device (3-7, 99, 111a-e, 113a-d, 115a-d, 116a-e, 127-129, 134-135) exhibit respectively means for height adjustment.

24. A device according to claim 22, so characterized that the rear support legs (32-33) of the base element (25) are built from the lower end of the section rails (34, 35, 98).

25. A device according to claim 22, so characterized that beneath the support legs (30-33) of the base element (25) rollers are provided for rolling the device (3-7, 99, 111a-e, 113a-d, 115a-d, 116a-e, 127-129, 134-135).

26. A device according to claim 1, so characterized that the base element (25) and the retaining element (26,138,139) are removable and can be put together again.

27. A device according to claim 1, so characterized that the base element (25) and the retaining element (26) are constructed as being capable of folding up.

28. A kitchen installation with devices according to claim 1, so characterized that that the devices (3-7, 99, 111a-e, 113a-d, 115a-d, 116a-e, 127-129,134-135) are laid out side by side for building a kitchen unit (2, 109, 110).
